(19) United States
(12) Patent Application Publication
(10) Pub. No.: US 2018/0072121 A1
(43) Pub. Date: Mar. 15, 2018

(54) TRUNNION-TYPE VEHICLE SUSPENSION SYSTEM

(71) Applicant: WATSON & CHALIN MANUFACTURING, INC., McKinney, TX (US)

(72) Inventor: Michael GOTTSCHALK, McKinney, TX (US)

(21) Appl. No.: 15/557,736

(22) PCT Filed: Mar. 18, 2015
(86) PCT No.: PCT/US2015/021207

§ 371 Date: Sep. 12, 2017

(51) Int. Cl. B60G 5/053; B60G 11/04

(52) U.S. Cl. CPC B60G 5/053; B60G 2206/8201; B60G 11/04

(57) ABSTRACT

A vehicle suspension system can include a trunnion tube positioned between two axles, and at least one spring set attached to the axles and rotatably attached to the trunnion tube. An outer diameter of the trunnion tube can be substantially equal to an outer diameter of the axles. In another example, two of the trunnion stands can be positioned entirely between two of the spring sets and welded to the trunnion tube. In yet another example, a ratio of a distance between axle centers to an outer diameter of the trunnion tube can be less than 11 to 1. In a further example, the trunnion tube and the axles may be made of a same material. In a still further example, a ratio of the outer diameter of the trunnion tube to a wall thickness of a bushing on the trunnion tube can be greater than 9 to 1.

### CROSS-REFERENCE TO RELATED APPLICATION

This application is a national stage under 35 USC 371 of International Application No. PCT/US15/21207, filed on 18 Mar. 2015. The entire disclosure of this prior application is incorporated herein by this reference.

### BACKGROUND

This disclosure relates generally to vehicle suspension systems and, in one example described below, more particularly provides for improved construction of vehicle suspension systems.

Suspension system design significantly affects ride quality and load carrying capacity of a vehicle. At least for commercial vehicles, it is typically desirable to maximize the load carrying capacity, while providing for acceptable ride quality, reduced cost and economic maintenance. Therefore, it will be readily appreciated that improvements are continually needed in the art of constructing vehicle suspension systems.

### BRIEF DESCRIPTION OF THE DRAWINGS

FIG. 1 is a representative partially cross-sectional view of an example of a vehicle that can embody principles of this disclosure.

FIG. 2 is a representative perspective view of an example of a suspension system that may be used with the vehicle of FIG. 1, and which can embody the principles of this disclosure.

FIG. 3 is a representative side elevational view of the suspension system.

FIG. 4 is a representative cross-sectional view of the suspension system, taken along line 4-4 of FIG. 3.

FIG. 5 is a representative enlarged scale perspective view of a trunnion stand portion of the suspension system, indicated as detail 5 in FIG. 2.

FIG. 6 is a representative rear elevational view of a spring clamp and axle portion of the suspension system.

### DETAILED DESCRIPTION

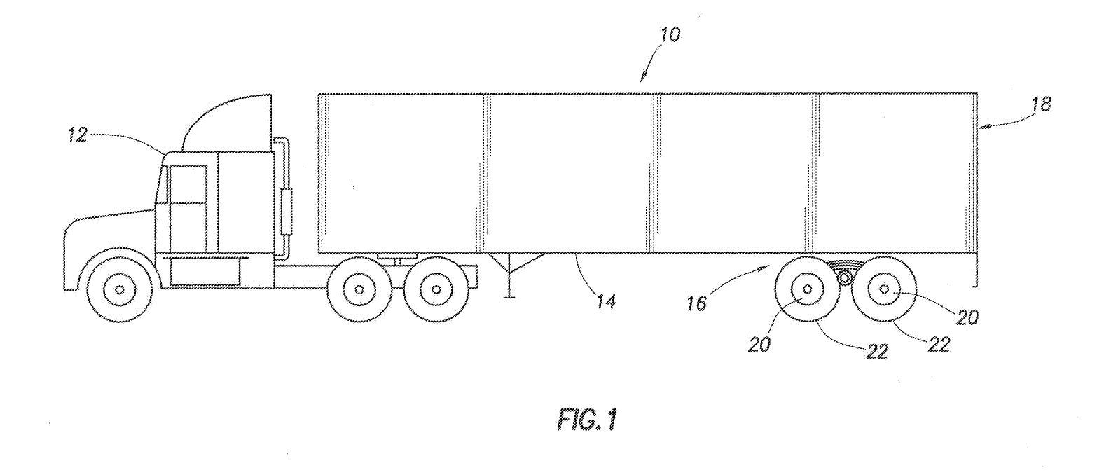

Representatively illustrated in FIG. 1 is a vehicle 10 that can embody principles of this disclosure. However, it should be clearly understood that the vehicle 10 is merely one example of an application of the principles of this disclosure in practice, and a wide variety of other examples are possible. Therefore, the scope of this disclosure is not limited at all to the details of the vehicle 10 described herein and/or depicted in the drawings.

The vehicle 10 is depicted as including a tractor 12 and a trailer 18. It is contemplated that the principles of this disclosure can be incorporated into a trailer of any type (as well as other types of vehicles), and so the term “vehicle” is used herein to refer to trailers of various types, as well as to refer to self-propelled vehicles.

The trailer 18 of FIG. 1 includes a suspension system 16 which suspends a frame 14 of the trailer above a road surface. Wheels 20 and tires 22 are rotatably mounted at each end of the suspension system 16 (such as, via spindles, hubs and bearings, in a manner well known to those skilled in the art) for rolling engagement with the road surface.

Although the trailer 18 of FIG. 1 is depicted as an enclosed box or cargo-type trailer, other types of trailers (such as, flat bed trailers, dump trailers, etc.) may incorporate the principles of this disclosure. Thus, the scope of this disclosure is not limited to use with any particular type of vehicle or trailer.

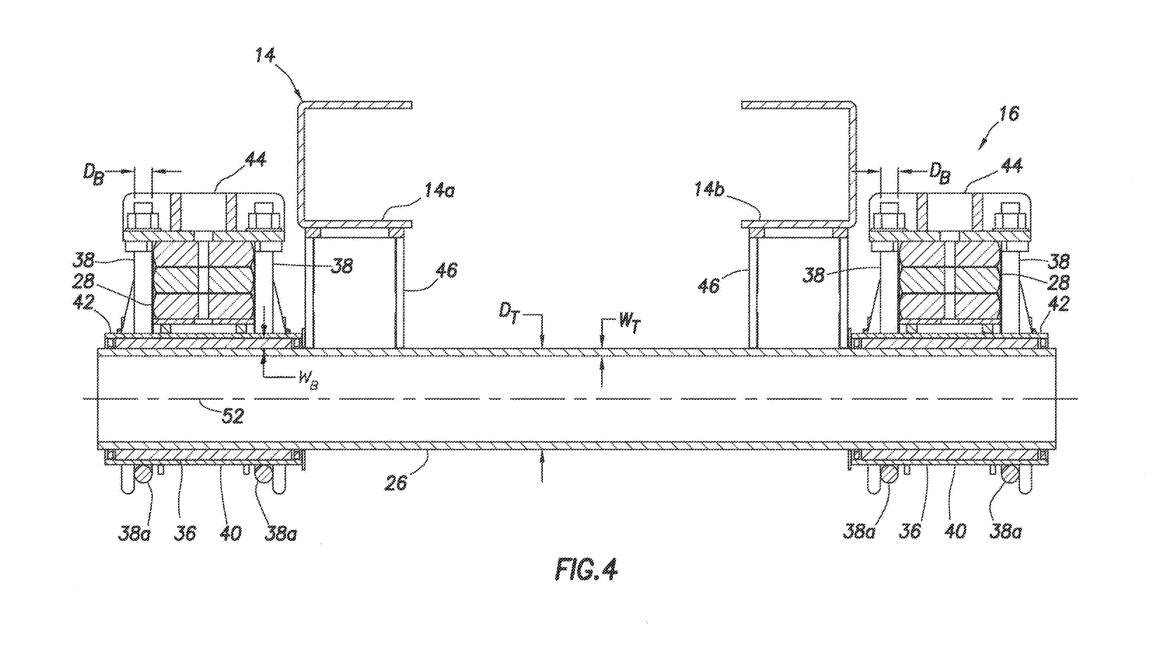

The frame 14 comprises multiple rails 14a,b (see FIG. 4) extending substantially an entire length of the trailer 18. However, in other examples, the frame 14 may have other numbers of rails, or may not extend the entire length of the trailer 18 or other vehicle.

As described more fully below, the suspension system 16 can be constructed in a manner that reduces its weight, thereby reducing a gross weight of the vehicle 10 and/or reducing its tare weight, so that more load can be hauled for a given gross weight of the vehicle. However, it is not necessary for the weight of the suspension system 16 to be reduced in comparison to any other particular suspension system, since the principles of this disclosure may be used, for example, to increase a load carrying capacity of the suspension system, to increase a reliability of the suspension system, to decrease maintenance requirements of the suspension system, or to accomplish any other purpose.

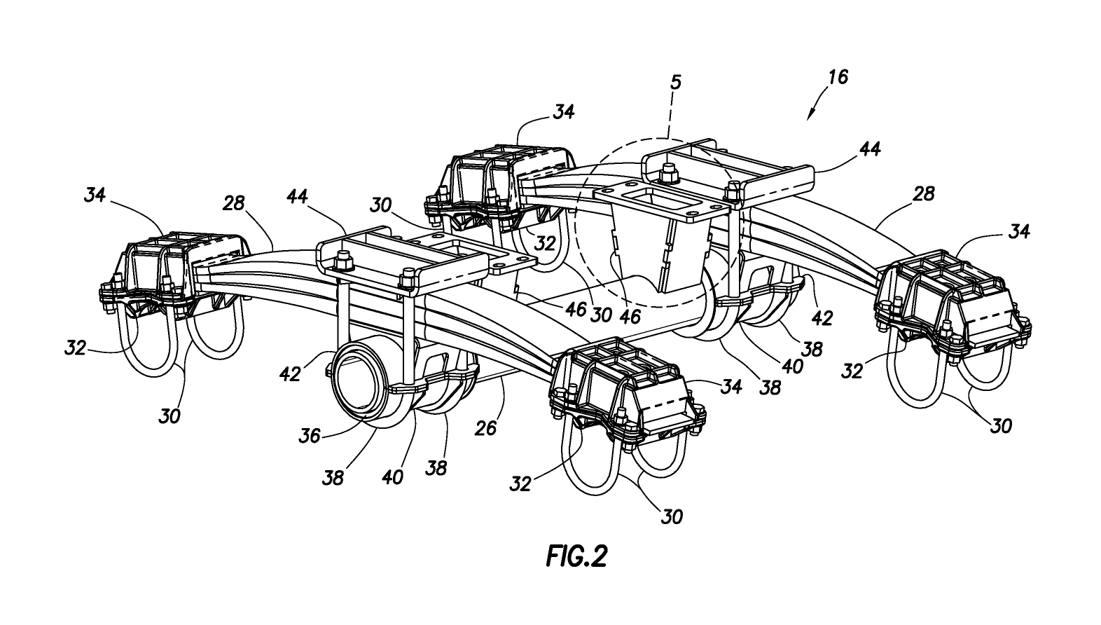

Referring additionally now to FIG. 2, an example of the suspension system 16 is representatively illustrated, apart from the vehicle 10 of FIG. 1. Of course, the suspension system 16 may be used with vehicles other than the vehicle 10, in keeping with the scope of this disclosure.

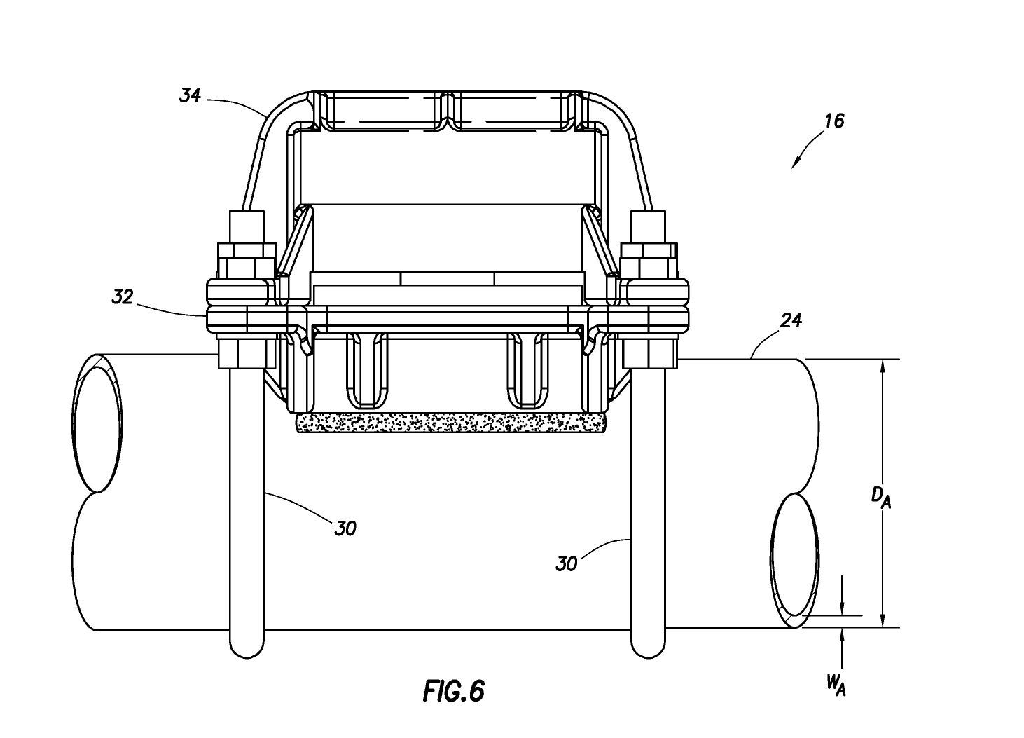

For clarity of illustration, only a portion of the suspension system 16 is depicted in FIG. 2. Certain other elements (such as the wheels 20, tires 22 (see FIG. 1) and axles 24 (see FIG. 6)) are not shown in FIG. 2, but would be part of the suspension system 16 in actual practice. For example, an axle 24 would extend laterally between spindles rotatably supporting each set of wheels 20, so that a trunnion tube 26 of the suspension system 16 is positioned between two axles (with the axles and sets of springs 28 being secured to each other by means of fasteners 30, as depicted in the example of FIG. 6).

The spring sets 28 in this example include multiple spring beams. However, in other examples, each spring set 28 could include just a single spring beam.

An axle seat 32 and a spring clamp 34 at each end of each spring set 28 are used to secure the end of the spring set to the corresponding axle 24. The spring sets 28 can, thus, bias the axles 24 downwardly or, viewed from another perspective, the trunnion tube 26 can be suspended between the axles 24 and biased upwardly by the spring sets.

The spring sets 28 are rotatably secured at opposite ends of the trunnion tube 26 by means of bushings 36, fasteners 38, trunnion clamps 40, trunnion seats 42 and spring clamps 44. The bushings 36 allow the spring sets 28, fasteners 38, trunnion clamps, trunnion seats 42 and spring clamps 44 to rotate relative to the trunnion tube 26.

The fasteners 30, 38 are depicted in the drawings as being U-bolts. However, other types of fasteners (such as straight bolts, hucks, etc.) may be used in other examples.

Trunnion stands 46 are used to rigidly secure the trunnion tube 26 to the vehicle frame rails 14a,b as described more fully below. The trunnion stands 46 also space the trunnion tube 26 vertically below the frame rails 14a,b. Note that the trunnion stands 46 are laterally adjacent respective ones of the spring sets 28, which are also positioned above the trunnion tube 26 in this example. The trunnion stands 46 are also positioned entirely between the spring sets 28.

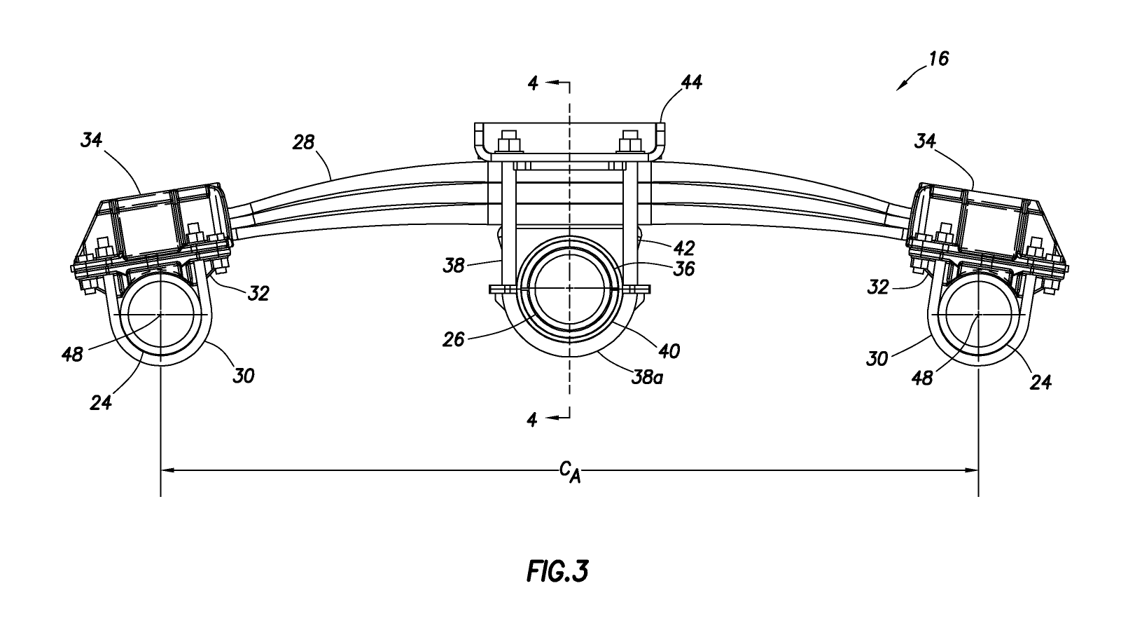

Referring additionally now to FIG. 3, a side elevational view of the suspension system 16 is representatively illustrated. In this view, it may be clearly seen that the trunnion tube 26 (and, thus, the vehicle frame 14 via the trunnion stands 46) is suspended by the spring sets 28 between the axles 24.

Note that centers 48 of the axles 24 are spaced apart by a distance C_{A}. The distance C_{A} can vary somewhat, depending on how much vertical load is applied to the trunnion tube 26 (e.g., depending on whether or not a load is being carried by the vehicle 10 and, if so, how much load). Flexure of the spring sets 28 in response to loading determines how the center-to-center distance C_{A} varies.

It may also be clearly seen in FIG. 3 how a curved portion 38a of the U-bolt fastener 38 wraps partially about the trunnion tube 26. Since the fastener 38 conforms relatively closely to a shape of the trunnion tube 26, the trunnion clamp 40 can be made thinner and lighter, with the fastener portion 38a contributing structurally to clamping of the trunnion tube. In addition, since the spring clamp 44 does not need to conform to the curved portion 38a of the fastener 38, the spring clamp can also be made thinner and lighter, while still providing for appropriate clamping of the spring set 28.

Referring additionally now to FIG. 4, a cross-sectional view of the suspension system 16 is representatively illustrated, taken along line 4-4 of FIG. 3. In this view, the frame rails 14a,b are also depicted, so that their spatial relationship to the trunnion stands 46 can be more readily appreciated.

In this example, the trunnion stands 46 are welded to the trunnion tube 26 during manufacture of the suspension system 16. To attach the suspension system 16 to the frame 14, the trunnion stands 46 are first bolted to the frame rails 14a,b and then the trunnion stands are welded to the frame rails. Of course, different attachment methods, or different combinations of attachment methods, may be used in other examples.

An outer diameter D_{T} of the trunnion tube 26 can be made relatively large, and a wall thickness W_{T} of the trunnion tube can be made relatively thin, in order to facilitate reducing a weight of the trunnion tube and associated components. In one example, the trunnion tube 26 may be made from drawn-over-mandrel (DOM) steel tubing having an outer diameter D_{T} of approximately five inches (˜12.7 cm) and a wall thickness W_{T} of approximately ⅜ or ½ inch (˜0.95 or 1.27 cm, respectively). Of course, other materials and/or dimensions may be used in other examples.

By increasing the outer diameter D_{T}, a wall thickness W_{B} of the bushing 36 can be reduced. This increases a conical stiffness of the spring set 28 to trunnion tube 26 interface, thereby providing better lateral control in the suspension system 16. In one example, the bushing 36 wall thickness W_{B} can be approximately 0.525 inches (˜1.33 cm). A ratio of the outer diameter D_{T} of the trunnion tube 26 to the wall thickness W_{B} of the bushing 36 in this example can be 9.52:1. In some examples, this ratio (D_{T}/W_{B}) can be greater than 9:1. Of course, other dimensions and other ratios may be used in keeping with the principles of this disclosure.

In the FIGS. 3 & 4 example, a ratio of the axles 24 center-to-center dimension C_{A} to the trunnion tube 26 outer diameter D_{T} can be less than 11 to 1. As the trunnion tube 26 outer diameter D_{T} increases, the ratio (C_{A}/D_{T}) decreases. Such ratio decrease can provide weight savings, greater strength to weight ratios and other benefits.

In one preferred example, the ratio (C_{A}/D_{T}) can be approximately 10.03:1 with the suspension system 16 unloaded, and approximately 10.25:1 with the suspension system loaded. Greater or lesser ratios may be used without departing from the scope of this disclosure.

In the FIGS. 3 & 4 example, the U-bolt fasteners 38 have a bolt diameter D_{B} that is large enough to provide sufficient clamping force, but is not too large so as to contribute excessive weight to the suspension system 16. In this example, a ratio of the bolt diameter D_{B} to the trunnion tube 26 wall thickness W_{T} can be greater than 1½ to 1. As the wall thickness W_{T} decreases, the ratio (D_{B}/W_{T}) increases. Such ratio increase can provide weight savings, greater strength to weight ratios and other benefits.

In some preferred examples, the ratio (D_{B}/W_{T}) can be approximately 2.25:1 or 3.00:1. Greater or lesser ratios may be used without departing from the scope of this disclosure.

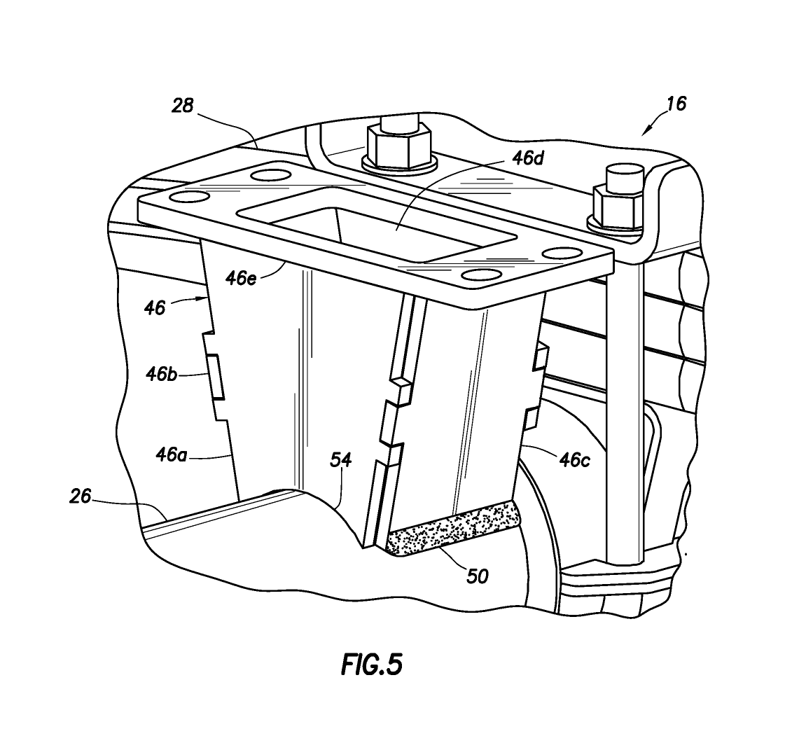

Referring additionally now to FIG. 5, an enlarged scale view is representatively illustrated of a portion of the suspension system 16 (indicated as detail 5 in FIG. 2). This portion of the suspension system 16 includes one of the trunnion stands 46 as welded to the trunnion tube 26.

Note that the trunnion stand 46 in this example is made up of multiple individual components 46a-e that are separately formed and then welded together. Thus, the trunnion stand 46 in this example is a “fabricated” trunnion stand. In other examples, the trunnion stand 46 could be cast, forged or otherwise formed, as a single component or as multiple separate components.

The trunnion stand 46 is welded directly to the trunnion tube 26 along forward and rearward interfaces between the trunnion stand and the trunnion tube. In FIG. 5, a linear weld 50 between the trunnion stand component 46c and the trunnion tube 26 extends in a direction that is parallel to a longitudinal axis 52 of the trunnion tube (see FIG. 4). Similarly, another weld 50 (not visible in FIG. 5) between the trunnion stand component 46b and the trunnion tube 26 extends parallel to the trunnion tube longitudinal axis 52.

In this example, all welds 50 between the trunnion stand 46 and the trunnion tube 26 extend only parallel to the trunnion tube longitudinal axis 52. For example, there are no welds used at a curved circumferential interface 54 between the trunnion tube 26 and each of the trunnion stand components 46a,d.

By use of the substantially linear welds 50 parallel to the trunnion tube longitudinal axis 52 and at or toward a neutral axis of the trunnion tube 26, stress concentrations can be reduced, thereby enhancing a strength of the trunnion tube to trunnion stand 46 attachment and increasing its resistance to fatigue failure. However, it is not necessary in keeping with the principles of this disclosure for the welds 50 to extend only linearly and/or only parallel to the trunnion tube longitudinal axis 52. For example, some variations in the welds 50 could be used in other embodiments.

Referring additionally now to FIG. 6, a detailed view of one of the axle 24, axle seat 32 and spring clamp 34 attachments is representatively illustrated, apart from the remainder of the suspension system 16. In this view, it may be seen that the axle seat 32 is welded to the axle 24, and the spring clamp 34 is secured to the axle seat (and the axle) using the U-bolt fasteners 30. In this manner, an end of the corresponding spring set 28 is connected to the axle 24.

The axle 24 has an outer diameter D_{A} and a wall thickness W_{A}. In this example, the axle 24 outer diameter D_{A} is substantially the same as the trunnion tube 26 outer diameter D_{T}, and the axle wall thickness W_{A} is substantially the same as the trunnion tube wall thickness W_{T}. The terms “substantially the same as” and “substantially equal to” are used herein to encompass small variations, such as, due to manufacturing tolerances, specific configuration requirements (e.g., a small difference in axle, trunnion or spring clamps), etc.

Note that it is not necessary for the axle 24 outer diameter D_{A} to be substantially the same as the trunnion tube 26 outer diameter D_{T}, or for the axle wall thickness W_{A} to be substantially the same as the trunnion tube wall thickness W_{T}. Different outer diameters and wall thicknesses may be used, in keeping with the principles of this disclosure.

In the examples described above, a material of the trunnion tube 26 may be the same as a material of the axles 24. For example, DOM steel tubing may be used for both of the trunnion tube 26 and the axles 24. In this manner, equivalent welding procedures may be used for welding the trunnion stands 46 to the trunnion tube 26 as for welding the axle seats 32 to the axles 24. However, different materials may be used for the axles 24 and trunnion tube 26 in other examples.

It may now be fully appreciated that the above disclosure provides significant advancements to the art of constructing vehicle suspension systems. In one example described above, a relatively large diameter and reduced wall thickness trunnion tube 26 can provide for reduced weight, increased structural integrity, decreased ratio of axle 24 center-to-center dimension to trunnion tube outer diameter (C_{A}/D_{T}), increased ratio of fastener 38 bolt diameter to trunnion tube wall thickness (D_{B}/W_{T}) and other benefits. However, it is not necessary for all of these benefits to be achieved in a suspension system incorporating principles of this disclosure.

A vehicle suspension system 16 is provided to the art by the above disclosure. In one example, the suspension system 16 can include a trunnion tube 26 positioned between two axles 24, and at least one spring set 28 attached to both of the axles. The spring set 28 is rotatably attached to the trunnion tube 26. An outer diameter D_{T} of the trunnion tube 26 is substantially equal to an outer diameter D_{A} of each of the axles 24.

A wall thickness W_{T} of the trunnion tube 26 may be substantially equal to a wall thickness W_{A} of each of the axles 24.

At least one U-bolt (e.g., fastener 38) may secure the spring set 28 to the trunnion tube 26. The U-bolt can include a curved portion 38a that wraps partially about the trunnion tube 26. The spring set 28 may be positioned above the trunnion tube 26. In other examples, the spring set 28 may be positioned below the trunnion tube 26.

The vehicle suspension system 16 can include at least one trunnion stand 46 rigidly attached to the trunnion tube 26 and to a vehicle frame 14. The trunnion stand 46 can be welded directly to the trunnion tube 26. In other examples, the trunnion stand 46 may not be welded directly to the trunnion tube 26 (e.g., another component could be disposed between the trunnion stand and the trunnion tube).

A weld 50 between the trunnion stand 46 and the trunnion tube 26 may extend in a direction substantially parallel to a longitudinal axis 52 of the trunnion tube. The weld 50 between the trunnion stand 46 and the trunnion tube 26 may extend only in a direction substantially parallel to the longitudinal axis 52 of the trunnion tube.

The vehicle suspension system 16 can include at least one trunnion stand 46 rigidly attached to the trunnion tube 26 and to a vehicle frame 14, the spring set 28 being positioned above the trunnion tube, and at least one U-bolt 38 securing the spring set to the trunnion tube, the U-bolt including a curved portion 38a that wraps partially about the trunnion tube.

The trunnion stand 46 can comprise multiple welded together components 46a-e.

A ratio of a) a distance C_{A} between centers 48 of the axles 24 to b) an outer diameter D_{T} of the trunnion tube 26 may be less than 11 to 1.

At least one U-bolt 38 can secure the spring set 28 to the trunnion tube 26, and a ratio of a) a bolt diameter D_{B} of the U-bolt to b) a wall thickness W_{T} of the trunnion tube may be greater than 1½ to 1.

The vehicle suspension system 16 can include two trunnion stands 46 rigidly attached to the trunnion tube 26 and the vehicle frame 14. The “at least one” spring set 28 can comprise two spring sets, and the trunnion stands 46 may be positioned entirely between the spring sets.

The spring sets 28 may be positioned above the trunnion tube 26, and multiple U-bolts 38 can secure the spring sets to the trunnion tube, each of the U-bolts including a curved portion 38a that wraps partially about the trunnion tube.

The trunnion tube 26 and the axles 24 may be made of a same material (such as, DOM steel tubing or another material).

A bushing 36 can be positioned on the trunnion tube 26 (for example, partially or completely encircling the trunnion tube). A ratio of a) an outer diameter D_{T} of the trunnion tube 26 to b) a wall thickness W_{B} of the bushing 36 may be greater than 9 to 1.

Also described above is a vehicle suspension system 16 example that includes a trunnion tube 26 positioned between two axles 24, two spring sets 28 attached to both of the axles, and the spring sets being rotatably attached to the trunnion tube. Two trunnion stands 46 are positioned entirely between the spring sets 28, with the trunnion stands being welded to the trunnion tube 26.

In another example described above, a vehicle suspension system 16 can comprise a trunnion tube 26 positioned between two axles 24, and at least one spring set 28 attached to both of the axles, and the spring set being rotatably attached to the trunnion tube. A ratio of a) a distance C_{A} between centers 48 of the axles 24 to b) an outer diameter D_{T} of the trunnion tube 26 is less than 11 to 1.

Although various examples have been described above, with each example having certain features, it should be understood that it is not necessary for a particular feature of one example to be used exclusively with that example. Instead, any of the features described above and/or depicted in the drawings can be combined with any of the examples, in addition to or in substitution for any of the other features of those examples. One example's features are not mutually exclusive to another example's features. Instead, the scope of this disclosure encompasses any combination of any of the features.

Although each example described above includes a certain combination of features, it should be understood that it is not necessary for all features of an example to be used. Instead, any of the features described above can be used, without any other particular feature or features also being used.

It should be understood that the various embodiments described herein may be utilized in various orientations, such as inclined, inverted, horizontal, vertical, etc., and in various configurations, without departing from the principles of this disclosure. The embodiments are described merely as examples of useful applications of the principles of the disclosure, which is not limited to any specific details of these embodiments.

In the above description of the representative examples, directional terms (such as “above,” “below,” “upper,” “lower,” etc.) are used for convenience in referring to the accompanying drawings. However, it should be clearly understood that the scope of this disclosure is not limited to any particular directions described herein.

The terms “including,” “includes,” “comprising,” “comprises,” and similar terms are used in a non-limiting sense in this specification. For example, if a system, method, apparatus, device, etc., is described as “including” a certain feature or element, the system, method, apparatus, device, etc., can include that feature or element, and can also include other features or elements. Similarly, the term “comprises” is considered to mean “comprises, but is not limited to.”

Of course, a person skilled in the art would, upon a careful consideration of the above description of representative embodiments of the disclosure, readily appreciate that many modifications, additions, substitutions, deletions, and other changes may be made to the specific embodiments, and such changes are contemplated by the principles of this disclosure. For example, structures disclosed as being separately formed can, in other examples, be integrally formed and vice versa. Accordingly, the foregoing detailed description is to be clearly understood as being given by way of illustration and example only, the spirit and scope of the invention being limited solely by the appended claims and their equivalents.

What is claimed is:

1. A vehicle suspension system, comprising:
a trunnion tube positioned between two axles; and
at least one spring set attached to both of the axles, and the spring set being rotatably attached to the trunnion tube,
wherein an outer diameter of the trunnion tube is substantially equal to an outer diameter of each of the axles.

2. The vehicle suspension system of claim 1, wherein a wall thickness of the trunnion tube is substantially equal to a wall thickness of each of the axles.

3. The vehicle suspension system of claim 1, wherein at least one U-bolt secures the spring set to the trunnion tube, the U-bolt including a curved portion that wraps partially about the trunnion tube.

4. The vehicle suspension system of claim 3, wherein the spring set is positioned above the trunnion tube.

5. The vehicle suspension system of claim 1, further comprising at least one trunnion stand rigidly attached to the trunnion tube and to a vehicle frame, wherein the trunnion stand is welded directly to the trunnion tube.

6. The vehicle suspension system of claim 5, wherein a weld between the trunnion stand and the trunnion tube extends in a direction substantially parallel to a longitudinal axis of the trunnion tube.

7. The vehicle suspension system of claim 5, wherein a weld between the trunnion stand and the trunnion tube extends only in a direction substantially parallel to a longitudinal axis of the trunnion tube.

8. The vehicle suspension system of claim 1, further comprising at least one trunnion stand rigidly attached to the trunnion tube and to a vehicle frame, wherein the spring set is positioned above the trunnion tube, and wherein at least one U-bolt secures the spring set to the trunnion tube, the U-bolt including a curved portion that wraps partially about the trunnion tube.

9. The vehicle suspension system of claim 1, further comprising at least one trunnion stand rigidly attached to the trunnion tube and to a vehicle frame, wherein the trunnion stand comprises multiple welded together components.

10. The vehicle suspension system of claim 1, wherein a ratio of a) a distance between centers of the axles to b) an outer diameter of the trunnion tube is less than 11 to 1.

11. The vehicle suspension system of claim 1, wherein at least one U-bolt secures the spring set to the trunnion tube, and wherein a ratio of a) a bolt diameter of the U-bolt to b) a wall thickness of the trunnion tube is greater than 1½ to 1.

12. The vehicle suspension system of claim 1, further comprising two trunnion stands rigidly attached to the trunnion tube and to a vehicle frame, wherein the at least one spring set comprises two spring sets, and wherein the trunnion stands are positioned entirely between the spring sets.

13. The vehicle suspension system of claim 12, wherein the spring sets are positioned above the trunnion tube, and wherein multiple U-bolts secure the spring sets to the trunnion tube, each of the U-bolts including a curved portion that wraps partially about the trunnion tube.

14. The vehicle suspension system of claim 1, wherein the trunnion tube and the axles are made of a same material.

15. The vehicle suspension system of claim 1, further comprising a bushing positioned on the trunnion tube, and wherein a ratio of a) an outer diameter of the trunnion tube to b) a wall thickness of the bushing is greater than 9 to 1.

16. A vehicle suspension system, comprising:
a trunnion tube positioned between two axles;
two spring sets attached to both of the axles, and the spring sets being rotatably attached to the trunnion tube; and
two trunnion stands positioned entirely between the spring sets, the trunnion stands being welded to the trunnion tube.

17. The vehicle suspension system of claim 16, wherein an outer diameter of the trunnion tube is substantially equal to an outer diameter of each of the axles.

18. The vehicle suspension system of claim 16, wherein a wall thickness of the trunnion tube is substantially equal to a wall thickness of each of the axles.

19. The vehicle suspension system of claim 16, wherein multiple U-bolts secure the spring sets to the trunnion tube, each of the U-bolts including a curved portion that wraps partially about the trunnion tube.

20. The vehicle suspension system of claim 19, wherein the spring sets are positioned above the trunnion tube.

21. The vehicle suspension system of claim 16, wherein welds between the trunnion stands and the trunnion tube extend in a direction substantially parallel to a longitudinal axis of the trunnion tube.

22. The vehicle suspension system of claim 16, wherein welds between the trunnion stands and the trunnion tube extend only in a direction substantially parallel to a longitudinal axis of the trunnion tube.

23. The vehicle suspension system of claim 16, wherein each of the trunnion stands comprises multiple welded together components.

24. The vehicle suspension system of claim 16, wherein a ratio of a) a distance between centers of the axles to b) an outer diameter of the trunnion tube is less than 11 to 1.

25. The vehicle suspension system of claim 16, wherein multiple U-bolts secure the spring sets to the trunnion tube, and wherein a ratio of a) a bolt diameter of the U-bolts to b) a wall thickness of the trunnion tube is greater than 1½ to 1.

26. The vehicle suspension system of claim 16, wherein the trunnion tube and the axles are made of a same material.

27. The vehicle suspension system of claim 16, further comprising a bushing positioned on the trunnion tube, and wherein a ratio of a) an outer diameter of the trunnion tube to b) a wall thickness of the bushing is greater than 9 to 1.

28. A vehicle suspension system, comprising:
a trunnion tube positioned between two axles; and
at least one spring set attached to both of the axles, and the spring set being rotatably attached to the trunnion tube,
wherein a ratio of a) a distance between centers of the axles to b) an outer diameter of the trunnion tube is less than 11 to 1.

29. The vehicle suspension system of claim 28, wherein the outer diameter of the trunnion tube is substantially equal to an outer diameter of each of the axles.

30. The vehicle suspension system of claim 28, wherein a wall thickness of the trunnion tube is substantially equal to a wall thickness of each of the axles.

31. The vehicle suspension system of claim 28, wherein at least one U-bolt secures the spring set to the trunnion tube, the U-bolt including a curved portion that wraps partially about the trunnion tube.

32. The vehicle suspension system of claim 31, wherein the spring set is positioned above the trunnion tube.

33. The vehicle suspension system of claim 28, further comprising at least one trunnion stand rigidly attached to the trunnion tube and to a vehicle frame, wherein the trunnion stand is welded directly to the trunnion tube.

34. The vehicle suspension system of claim 33, wherein a weld between the trunnion stand and the trunnion tube extends in a direction substantially parallel to a longitudinal axis of the trunnion tube.

35. The vehicle suspension system of claim 33, wherein a weld between the trunnion stand and the trunnion tube extends only in a direction substantially parallel to a longitudinal axis of the trunnion tube.

36. The vehicle suspension system of claim 28, further comprising at least one trunnion stand rigidly attached to the trunnion tube and to a vehicle frame, wherein the spring set is positioned above the trunnion tube, and wherein at least one U-bolt secures the spring set to the trunnion tube, the U-bolt including a curved portion that wraps partially about the trunnion tube.

37. The vehicle suspension system of claim 28, wherein at least one U-bolt secures the spring set to the trunnion tube, and wherein a ratio of a) a bolt diameter of the U-bolt to b) a wall thickness of the trunnion tube is greater than 1½ to 1.

38. The vehicle suspension system of claim 28, further comprising two trunnion stands rigidly attached to the trunnion tube and to a vehicle frame, wherein the at least one spring set comprises two spring sets, and wherein the trunnion stands are positioned entirely between the spring sets.

39. The vehicle suspension system of claim 28, wherein the trunnion tube and the axles are made of a same material.

40. The vehicle suspension system of claim 28, further comprising a bushing positioned on the trunnion tube, and wherein a ratio of a) an outer diameter of the trunnion tube to b) a wall thickness of the bushing is greater than 9 to 1.

41. A vehicle suspension system, comprising:
a trunnion tube positioned between two axles; and
at least one spring set attached to both of the axles, and the spring set being rotatably attached to the trunnion tube,
wherein the trunnion tube and the axles are made of a same material.

42. The vehicle suspension system of claim 41, wherein the outer diameter of the trunnion tube is substantially equal to an outer diameter of each of the axles.

43. The vehicle suspension system of claim 41, wherein a wall thickness of the trunnion tube is substantially equal to a wall thickness of each of the axles.

44. The vehicle suspension system of claim 41, wherein at least one U-bolt secures the spring set to the trunnion tube, the U-bolt including a curved portion that wraps partially about the trunnion tube.

45. The vehicle suspension system of claim 44, wherein the spring set is positioned above the trunnion tube.

46. The vehicle suspension system of claim 41, further comprising at least one trunnion stand rigidly attached to the trunnion tube and to a vehicle frame, wherein the trunnion stand is welded directly to the trunnion tube.

47. The vehicle suspension system of claim 46, wherein a weld between the trunnion stand and the trunnion tube extends in a direction substantially parallel to a longitudinal axis of the trunnion tube.

48. The vehicle suspension system of claim 46, wherein a weld between the trunnion stand and the trunnion tube extends only in a direction substantially parallel to a longitudinal axis of the trunnion tube.

49. The vehicle suspension system of claim 41, further comprising at least one trunnion stand rigidly attached to the trunnion tube and to a vehicle frame, wherein the spring set is positioned above the trunnion tube, and wherein at least one U-bolt secures the spring set to the trunnion tube, the U-bolt including a curved portion that wraps partially about the trunnion tube.

50. The vehicle suspension system of claim 41, wherein at least one U-bolt secures the spring set to the trunnion tube, and wherein a ratio of a) a bolt diameter of the U-bolt to b) a wall thickness of the trunnion tube is greater than 1½ to 1.

51. The vehicle suspension system of claim 41, further comprising two trunnion stands rigidly attached to the trunnion tube and to a vehicle frame, wherein the at least one spring set comprises two spring sets, and wherein the trunnion stands are positioned entirely between the spring sets.

52. The vehicle suspension system of claim 41, wherein a ratio of a) a distance between centers of the axles to b) an outer diameter of the trunnion tube is less than 11 to 1.

53. The vehicle suspension system of claim 41, further comprising a bushing positioned on the trunnion tube, and wherein a ratio of a) an outer diameter of the trunnion tube to b) a wall thickness of the bushing is greater than 9 to 1.

54. A vehicle suspension system, comprising:
a trunnion tube positioned between two axles;
at least one spring set attached to both of the axles, and the spring set being rotatably attached to the trunnion tube; and
a bushing positioned on the trunnion tube,
wherein a ratio of a) an outer diameter of the trunnion tube to b) a wall thickness of the bushing is greater than 9 to 1.

55. The vehicle suspension system of claim 54, wherein the outer diameter of the trunnion tube is substantially equal to an outer diameter of each of the axles.

56. The vehicle suspension system of claim 54, wherein a wall thickness of the trunnion tube is substantially equal to a wall thickness of each of the axles.

57. The vehicle suspension system of claim 54, wherein at least one U-bolt secures the spring set to the trunnion tube, the U-bolt including a curved portion that wraps partially about the trunnion tube.

58. The vehicle suspension system of claim 57, wherein the spring set is positioned above the trunnion tube.

59. The vehicle suspension system of claim 54, further comprising at least one trunnion stand rigidly attached to the trunnion tube and to a vehicle frame, wherein the trunnion stand is welded directly to the trunnion tube.

60. The vehicle suspension system of claim 59, wherein a weld between the trunnion stand and the trunnion tube extends in a direction substantially parallel to a longitudinal axis of the trunnion tube.

61. The vehicle suspension system of claim 59, wherein a weld between the trunnion stand and the trunnion tube extends only in a direction substantially parallel to a longitudinal axis of the trunnion tube.

62. The vehicle suspension system of claim 54, further comprising at least one trunnion stand rigidly attached to the trunnion tube and to a vehicle frame, wherein the spring set is positioned above the trunnion tube, and wherein at least one U-bolt secures the spring set to the trunnion tube, the U-bolt including a curved portion that wraps partially about the trunnion tube.

63. The vehicle suspension system of claim 54, wherein at least one U-bolt secures the spring set to the trunnion tube, and wherein a ratio of a) a bolt diameter of the U-bolt to b) a wall thickness of the trunnion tube is greater than 1½ to 1.

64. The vehicle suspension system of claim 54, further comprising two trunnion stands rigidly attached to the trunnion tube and to a vehicle frame, wherein the at least one spring set comprises two spring sets, and wherein the trunnion stands are positioned entirely between the spring sets.

65. The vehicle suspension system of claim 54, wherein the trunnion tube and the axles are made of a same material.

66. The vehicle suspension system of claim 54, wherein a ratio of a) a distance between centers of the axles to b) an outer diameter of the trunnion tube is less than 11 to 1.
